(19) United States
(12) Patent Application Publication
(10) Pub. No.: US 2022/0309428 A1
(43) Pub. Date: Sep. 29, 2022

(54) GENERATING AND PRESENTING AN INTERACTIVE AUDIT REPORT

(71) Applicant: Reveal Why, LLC, Orem, UT (US)

(72) Inventors: Burke Clark Powers, Orem, UT (US); Manya Marie MAYES, Cape Charles, VA (US)

(21) Appl. No.: 17/213,042

(22) Filed: Mar. 25, 2021

(51) Int. Cl. G06Q 10/06; G06F 16/332; G06F 16/35; G06F 40/169; G06N 20/00

(52) U.S. Cl. CPC G06Q 10/06315; G06F 16/3328; G06F 16/355; G06F 40/169; G06N 20/00

(57) ABSTRACT

The present disclosure relates generally to systems and methods for generating and presenting a graphical representation of topic sentiment metrics with respect to an identified entity based on an evaluation of documents collected across one or more communication platforms (e.g., social networking platforms). In particular, systems disclosed herein involve collecting documents having text therein that identify one or more topics associated with an identified entity (e.g., organization, brand, product). The topics may be analyzed with respect to the individual users and/or relative to mentions by other individuals to determine sentiment metrics (e.g., importance, impact) for the corresponding documents and topics. The documents may be tagged with metadata indicating the topics, categories, and sentiment metrics to produce an interactive presentation that enables a user to navigate the topics and sub-topics, as well as easily identify original content from the collection of documents.

### BACKGROUND

Recent years have seen significant growth in the engagement of online users. Indeed, it is now common for social networking systems and other communication platforms to provide tools that enable users of various platforms to search and/or navigate content shared via a particular website or on multiple websites. This information can provide valuable insight into how certain entities (e.g., businesses, brands, products, etc.) are perceived by a wide variety of individuals. Searching and/or navigating content shared via web platforms, however, suffers from a variety of problems and drawbacks.

For example, as a result of increased engagement of online users, conventional systems for searching and presenting online content generally provide insufficient tools to enable users to accurately and effectively search through massive quantities of content. Indeed, effectively searching or navigating large quantities of digital content using conventional tools often requires specialized knowledge of search terms and Boolean operators, thereby preventing the vast majority of individuals from identifying relevant or helpful content. In addition, where massive quantities of content are shared across multiple platforms, conventional systems for searching and identifying relevant data have become unrealistic and computationally expensive.

As another example, collecting data across a wide variety of platforms poses difficulties where the data is often non-uniform, unstructured, and/or where the content itself is created without the purpose of topic analysis. Indeed, where conventional data collection systems may conduct formal surveys in which content is solicited for specific topics and where data is composed having a certain format or structure, these systems are generally limited to the information specifically collected for analysis purposes. While structured surveys provide useful information that can be analyzed using a variety of tools, these conventional systems and have limited utility and often fail to provide an accurate picture of population sentiment.

### BRIEF DESCRIPTION OF THE DRAWINGS

FIG. 1 illustrates an example environment including systems for generating and presenting an interactive graphical representation of an audit report in accordance with one or more embodiments.

FIG. 2 illustrates an example framework for presenting a category audit report and training a model of the category auditing system in accordance with one or more embodiments.

FIG. 3 illustrates an example workflow for generating and presenting a category audit report in accordance with one or more embodiments.

FIGS. 4A-4B illustrate an example graphical user interface of a client device for generating a category audit report and training an audit generation model in accordance with one or more embodiments.

FIGS. 5A-5C illustrate an example graphical user interface of a client device for presenting a graphical representation of an audit report showing metrics of relative importance and impact of various topics and categories in accordance with one or more embodiments.

FIG. 6 illustrates a dynamic graphical representation of an audit report showing changes in metrics of relative importance and impact of various topics and categories in accordance with one or more embodiments.

FIG. 7 illustrates another example graphical user interface showing an interactive display of an audit report in accordance with one or more embodiments.

FIG. 8 illustrates an example series of acts for generating and presenting a graphical representation of an audit report for an associated entity in accordance with one or more embodiments.

FIG. 9 illustrates certain components that may be included within a computer system.

### DETAILED DESCRIPTION

The present disclosure relates generally to systems and methods for training and implementing an audit generation model and generating a graphical representation showing metrics of importance and impact of topics identified within an audit report. In particular, as will be discussed in further detail below, one or more embodiments described herein involve analyzing a collection of documents to determine sentiment metrics (e.g., impact, importance) associated with various categories and sub-categories. Based on the determined sentiment metrics, the topic visualization system may generate and present a graphical representation showing the metrics of impact and important for various categories with respect to an identified entity (e.g., a business entity, a brand, a product, etc.)

As an illustrative example, one or more embodiments described herein involve a topic visualization system that receives a collection of documents including text content associated with one or more entities. The topic visualization system can further tag the documents with metadata indicating any number of identified topics or categories based on analysis of the text content included within the documents. The topic visualization system may further determine metrics of importance and metrics of impact associated with the one or more entities. The topic visualization system may further provide a graphical representation including interactive elements representative of various topics based on the determined metrics of importance and impact for the respective topics.

As will be discussed in further detail below, the present disclosure includes a number of practical applications having features described herein that provide benefits and/or solve problems associated with collecting documents and visualizing sentiment metrics associated with various topics with respect to an identified entity. Some example benefits are discussed herein in connection with features and functionalities provided by a topic visualization system. Nevertheless, it will be appreciated that benefits explicitly discussed in connection with one or more implementations herein are provided by way of example and are not intended to be an exhaustive list of all possible benefits of the topic visualization system.

For example, as will be discussed in further detail below the various systems implement features and functionality that provide a uniform and automated analysis of documents from a plurality of document sources. For instance, one or more embodiments described herein involve tracking mentions and instances of topics that are discussed with respect to a variety of entities (e.g., companies, organizations, brands, products) across multiple communication platforms. In addition to analyzing and visualizing sentiment metrics for various topics across multiple platforms, the topic visualization system facilitates analyzing text content of various formats, including non-structured text, structured text, or a combination of both.

As another example, the topic visualization system provides interactive tools that enable an individual to view and effectively navigate sentiment metrics (e.g., importance metrics, impact metrics) associated with various topics when discussed with respect to a particular entity. For example, as will be discussed in further detail below, the topic visualization system can general and provide a graphical representation in which selective topics that are determined to be most impactful are displayed and with which interaction is possible in a variety of formats. As will be further discussed, the topic visualization system enables an individual to drill down on respective categories to view sentiment metrics for topics or sub-categories as well as obtaining access to source documents that have metadata tagged to the corresponding topics/categories.

Moreover, in each of the above examples, the various systems utilize machine learning and other automation tools that facilitate accurate analysis as well as dynamic analysis based on an availability of new documents. For example, and as discussed below, the category audit system can implement feedback training features that enable users to further refine algorithms and models utilized in determining importance, impact, and other sentiment metrics with respect to the specific documents and/or various topics. This feedback, in addition to mechanisms for collecting additional documents and incorporating them into the analysis, further provides features and functionality that enable an individual to view changing trends over time as well as evaluate performance within a particular organization.

As illustrated in the foregoing discussion, the present disclosure utilizes a variety of terms to describe features and advantages of the systems disclosed herein. Additional detail is not provided regarding the meaning of some of these terms.

As used herein, a “document” or “electronic document” refers to any portion of digital content (e.g., a digital content item). For example, a document may refer to a defined portion of digital data (e.g., a data file) including, but not limited to, digital media, electronic document files, contact lists, folders, or other digital objects. In addition, in one or more embodiments described herein, a document refers to digital content shared via a social networking platform such as a post, message, comment, user-rating, or other digital content shared between users of the social networking platform. In addition to digital content provided by social networking platforms, documents may originate from any number of sources including, by way of example, blogs, news sites, forums, or other online sources. Documents may further include digital content originating from other sources such as call center logs, handwritten documents (e.g., a downloaded collection of physical documents), survey responses (e.g., including unstructured data and/or survey responses), etc. A document may refer to a user-composed document (e.g., a post or message including text composed by an individual) or a shared document (e.g., a post that is forwarded or shared to any number of recipients). As used herein, a “collection of documents” refers to a plurality of documents of similar or different types, which may include documents obtained from a single source (e.g., a single platform) or across multiple sources (e.g., third-party server devices, different platforms). It will be appreciated that while one or more embodiments described herein refer specifically to documents including text (e.g., structured or unstructured), it will be appreciated that documents may include other types of content including, by way of example, images, videos, and other structure or non-structured data.

As used herein, a “search query” refers to a query provided by a client device as part of a request to search for results from a collection of documents. A search query may include a user-composed text string including any number of terms. In addition, or as an alternative, a search query may include one or more selected terms (e.g., categories, keywords) to include in selectively identifying documents or portions of documents from the collection of documents in response to the search query. Further, a search query may include an indication of one or more terms or series of words to exclude or otherwise utilize to filter or exclude from prospective results (e.g., negative terms).

As used herein, a “refined search query” refers to a variation or modification of a search query received as part of a request to search a collection of documents. As will be discussed in further detail below, a refined search query may refer to a query generated by the category auditing system using an audit generation model in accordance with one or more embodiments described herein. The refined search query may include one or more latent terms or variables based on historical data associated with previously generated audit reports. For example, the category auditing system may identify one or more latent variables such as adding a new search term not included within an original search query, removing a term (e.g., an irrelevant search term) included within the original search query, and/or emphasizing one search term over other search terms included within the search query to more accurately navigate or identify results from within the collection of documents.

In one or more embodiments described herein, the category auditing system identifies or otherwise extracts portions from the collection of documents corresponding to the refined search query. As used herein, “extracted portions” or “query results” refer interchangeably to documents or portions of documents that match or otherwise correspond to the refined search query. For example, an extracted portion or query result may refer to a snippet (e.g., a text snippet) from a document determined to be relevant to the refined search query based on an analysis of the search query (e.g., using natural language processing or other query analysis methods) and application of the analysis to the collection of documents. In one or more implementations, an extracted portion or query result may include an image, video, or other portion of a source document other than text snippets. Indeed, an extracted portion of a source document or query result may include a combination of text, images, or other type of digital content that may be consumed via a client device.

As mentioned above, the category auditing system can generate and provide an audit report to a client device. As used herein, an “audit report” includes a file or documents including a representation of any number of results (e.g., extracted portions) of a search query. For example, the audit report may include a webpage, document file, or other data object including selected information from the collection of documents determined or otherwise predicted to be relevant based on the refined search query. In one or more embodiments, the audit report includes one or more selection options that enables an end-user to provide feedback indicating whether one or more results are more or less relevant to the search query than other results within the audit report. As will be discussed in further detail below, an audit report may include any information associated with a search query, refined search query, and/or results of the search query. Indeed, in one or more embodiments, an audit report may include information about an audit generation model used for generating the audit report. Additional detail with regard to information that may be included within an audit report is provided in further detail below.

In one or more embodiments, the category auditing system utilizes an audit generation model to generate the audit report. In particular, the category auditing system may implement an audit generation model trained to perform some or all of the acts described herein that make up the process of generating and providing the audit report. In one or more embodiments, the audit generation model includes algorithms and/or models that carry out statistical sensitivity analysis of driving factors that explain the variance in a forecast or quantify the elasticity of factors within a forecast. In one or more embodiments, the audit generation model may include one or more algorithms or discrete models trained to perform tasks including generating a refined search query, selectively identifying a subset of a collection of documents to preserve processing resources, extracting relevant portions of documents in response to a search query, and determining information to provide within an audit report. In one or more embodiments, the audit generation model includes one or multiple machine learning models. In addition, or as an alternative, the audit generation model may include various algorithms, filtering rules, or other algorithms to enable the audit generation model to more accurately identify relevant results in response to a search query.

In one or more implementations, an algorithm or model may be trained using a sample set of training data, which may further be used to process all original search results that have been returned to search for accuracy and determine whether a query should be changed. For example, while one or more embodiments described herein describe generating a refined search query prior to generating the audit report, the category audit system may alternatively generate an audit report based on the original search query and, based on result feedback, provide recommendations or additional terms or variables to consider in generating a new search query as part of a process of generating a new audit report for the same user or device (e.g., rather than or in addition to gradually refining the algorithms or models over time).

As used herein, a “topic” or “category” may refer interchangeably to an identified subject of a document or portion of a document. For example, a topic may refer to any adjective, noun, adverb, or any descriptor that is associated with a particular entity. A topic or category may be used to describe any number of entities, such as a brand, a product, a business, an organization, an individual, or any other entity. In one or more embodiments, a category may refer to a particular subject while a topic refers to a sub-category of one or more sub-categories that fall within the higher level category. Some embodiments may include multiple levels of sub-categories (or topics) under the umbrella of a higher level category.

As used herein, a “sentiment metric” may refer to any metric or value descriptive of a topic or category. In one or more embodiments, a sentiment metric may provide some indication about how one or more individuals associated with a collection of documents feel about a particular topic. In one or more embodiments, a sentiment metric refers to an importance metric and/or an impact metric (or a combination of both). The sentiment metric may be determined based on any number of factors. In one or more embodiments, the sentiment metric is determined by one or more models (e.g., audit generation model, importance model, impact model) implemented on one or across multiple systems described herein.

As used herein, a “graphical representation” may refer to a presentation including content showing sentiment metrics for corresponding topics and/or categories with respect to an entity. For example, a graphical representation may show plotted points on a graph showing sentiment metrics for various topics with respect to a business, organization, brand, or other entity. As another example, a graphical representation may refer to a pie chart, bar chart, or any representation that shows scales of sentiment metrics with respect to various topics. As will be discussed in further detail herein, a graphical representation may be displayable via a graphical user interface of a client device and include any number of interactive elements that enable an individual to manipulate a display of the presentation as well as view source documents and additional information about respective sentiment metrics and/or specific topics/categories.

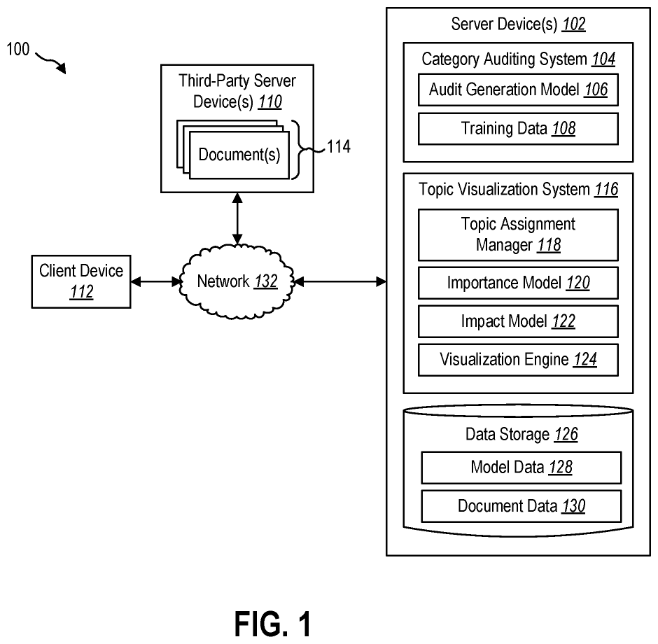

Additional detail will now be provided regarding systems disclosed herein in relation to illustrative figures portraying example implementations. For example, FIG. 1 illustrates an example environment 100 including a category auditing system 104 for generating and refining an audit report and a topic visualization system 116 for generating a graphical representation of topics associated with one or more entities. One or more embodiments described herein may involve the topic visualization system 116 and the category auditing system 104 cooperatively collecting documents and generating a graphical visualization (e.g., where the topic visualization system 116 generates a graphical representation of an audit report associated with a corresponding entity). Alternative, in one or more embodiments, the topic visualization system 116 may operate independently in generating and displaying a graphical representation in accordance with one or more embodiments. Accordingly, while one or more embodiments described herein refer to separate features and functionalities of the respective systems 104, 116, in one or more embodiments, some or all of the features described herein may be implemented by the topic visualization system 116.

As shown in FIG. 1, the environment 100 includes server device(s) 102 including a category auditing system 104 and a topic visualization system 116 thereon. As further shown in FIG. 1, the category auditing system 104 includes an audit generation model 106 implemented thereon. The category auditing system 104 may additionally include a data storage having training data 108. As further shown, the server device(s) 102 may include a topic visualization system 116 including a topic assignment manager 118, importance model 120, impact model 122, and visualization engine 124. In one or more embodiments, the server device(s) 102 includes a data storage 126 including model data 128 and document data 130 stored thereon.

The environment 100 may further include third-party server device(s) 110 and a client device 112, which may be associated with an end-user. As shown in FIG. 1, the third-party server device(s) 110 may include a collection of documents 114 originating from any number of sources and platforms. Each of the client device 112, third-party server device(s) 110, and server device(s) 102 may communicate over a network 132. While FIG. 1 illustrates an example in which the category auditing system 104 and topic visualization system 116 are implemented on the server device(s) 102, one or more features and functionalities described herein in connection with the systems 104, 116 can similarly be implemented on the client device 112 (e.g., using a locally installed application) and/or on the third-party server device(s) 110.

The client device 112 may refer to any computing device associated with a user for use in providing and receiving data from the category auditing system 104. For example, the client device 112 may refer to a consumer electronic device including, by way of example, mobile devices, desktop computers, or other types of computing devices. Moreover, as mentioned above, the client device 112 and server devices can communicate over the network 132, which may refer to one or multiple networks that use one or more communication protocols or technologies for transmitting data. For example, the network 132 may include the Internet or another data link that enables transport of electronic data between server device(s) 102 and any other devices of the environment 100.

As mentioned above, the category auditing system 104 facilitates accurate and efficient identification of portions of documents related to a given search query generated by a client device. For example, in at least one embodiment, the client device 112 provides a search query, which may include a user-generated search query composed by a user of the client device 112. The search query may include any number or combination of different search elements (e.g., text, categories, images, or other types of digital content) usable for identifying corresponding query results. In one or more implementations, the search query includes free-form text and/or one or more selected categories or search terms to include within a request to search a collection of documents to identify relevant portions of the documents associated with the search query. The client device 112 may transmit or otherwise provide the search query to the category auditing system 104.

Upon receiving the search query, the category auditing system 104 may utilize the audit generation model 106 to generate a refined search query based on one or more algorithms that make up the audit generation model 106. In particular, the category auditing system 104 may utilize the audit generation model 106 to determine one or more latent variables to consider in applying the audit generation model 106 to a collection of documents for identifying relevant results in response to the search query. For example, the category auditing system 104 may replace one or more search terms from the search query with more relevant or helpful search terms to use in extracting portions of documents from the collection of documents.

As another example, the category auditing system 104 may add or subtract search terms from the original query received from the client device 112. For example, the category auditing system 104 may identify one or more exclusion terms or variables that include negative limitations for search results. Indeed, the category auditing system 104 can generate any number of latent variables to apply to the documents and/or modify the search query in a number of ways to more accurately and efficiently identify relevant portions (e.g., snippets) of the collection of documents.

The category auditing system 104 can additionally identify a collection of documents to search based on the search query. The category auditing system 104 can identify collections of documents from a number of different sources and in a variety of ways. For example, the category auditing system 104 can identify documents from a particular social networking platform (from a collection of shared posts) or between multiple platforms (e.g., hosted by the third-party server device(s) 110). The category auditing system 104 can identify documents from a combination of social networking systems and other platforms (e.g., a document database).

In identifying or obtaining a collection of documents, the category auditing system 104 can identify any number of documents that are associated with a corresponding entity. For example, the category auditing system 104 can identify any tags, markers, or other indicator that the documents are associated with the entity. This may involve identifying specific keywords, hashtags, or evaluating where and how the document originated. This may be performed by scanning web content or performing a platform search to identify specific keywords, hashtags, or other identifiers of a corresponding entity.

In one or more embodiments, where a document refers to a post made while at a location of a particular business, that document may be associated with the business (or other entity) based on location metadata associated with the document corresponding to a known location of the business. In one or more embodiments, a set or collection of documents is collected by the entity itself, in which case the documents may be associated with the entity. In one or more embodiments, documents can be manually tagged or associated with an entity using a manual process. In one or more embodiments, documents may be associated with an entity by applying a machine learning model trained to identify associations or relevance with a particular entity. In one or more embodiments, one or more of the above mechanisms may be used in identifying a collection of documents associated with a corresponding entity (or in identifying results of a search that involves identifying documents (e.g., document snippets) associated with the entity.

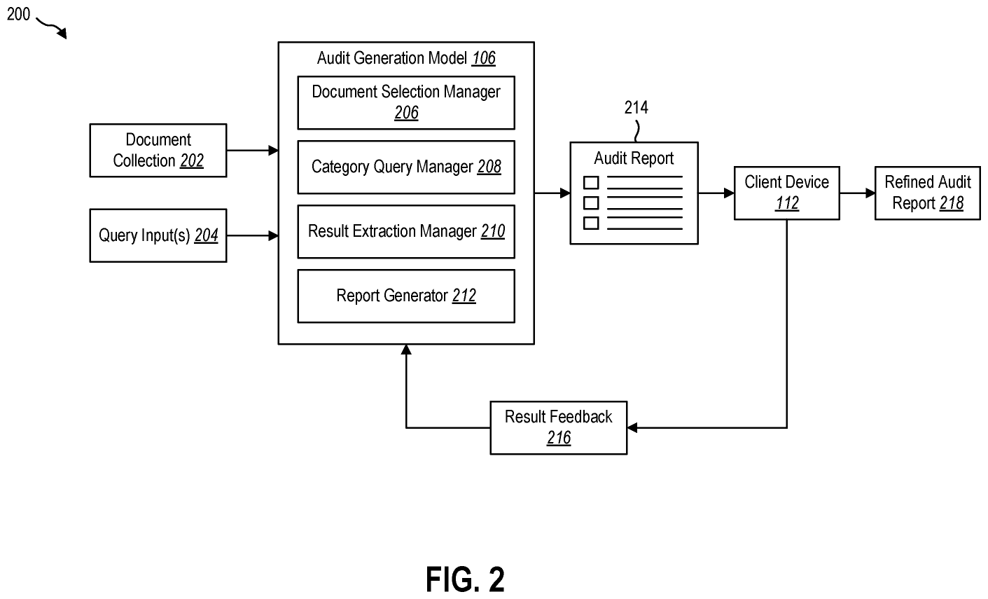

The collection of documents 114 may be utilized in a number of ways. As will be discussed below, in one or more embodiments, the collection of documents 114 may be identified for the purpose of identifying results to a query. For instance, in response to a search query that identifies a particular entity, any number of documents may be identified based on relevance to the queried entity. Additional detail in connection with this implementation will be described in connection with FIGS. 2-4B. In addition, or as an alternative, in one or more embodiments, the collection of documents 114 may be evaluated and tagged with metadata indicating one or multiple topics and/or categories referenced by or otherwise discussed within the respective documents, and in connection with a corresponding entity. Additional information in connection with categorizing and determining sentiment metrics with respect to the categories is discussed below.

As shown in FIG. 1, the category auditing system 104 may obtain documents from one or multiple third-party server device(s) 110. Indeed, the documents may include documents from any number of sources including, by way of example, a webpage, a collection of webpages, a remote database, a local database, a data storage system, or a social networking system. Moreover, the category auditing system 104 can identify a static collection of documents (e.g., a previously collected or non-changing collection of documents) or, alternatively, a dynamic collection of documents (e.g., a real-time feed of documents as they are shared to a social networking system and monitored or otherwise accessible in real-time by the category auditing system 104).

Upon generating the refined search query, the category auditing system 104 can apply the audit generation model 106 to the collection of documents based on the refined search query to generate an audit report. In particular, the category auditing system 104 can apply the audit generation model 106 to identify or extract portions of the collection of documents determined to be relevant to the search query based on the algorithms, rules, and training of the audit generation model 106. In one or more embodiments, the category auditing system 104 identifies snippets of the collection of documents determined to be relevant to the search query.

The category auditing system 104 can additionally provide the audit report to the client device 112 for presentation via a graphical user interface on the client device 112. For example, the category auditing system 104 can provide the audit report directly to the client device 112 over the network 114 to enable the client device 112 to provide a navigable and/or interactive display of the audit report. In one or more embodiments, the category auditing system 104 provides the audit report by providing a presentation of the audit report via a web interface on the client device 112. For example, the category auditing system 104 can generate the audit report and provide online access to the client device 112 for display via a navigable web interface. In one or more embodiments described herein, the presentable audit report includes a graphical representation showing sentiment metrics associated with various topics and/or categories associated with an entity (e.g., a searched entity).

As will be discussed in further detail below, client device 112 can enable a user of the client device 112 to interact with the audit report and provide result feedback indicating which results are more or less relevant to the search query. In one or more embodiments, the category auditing system 104 (or client device 112) provides selectable options that enable a user to interact with a presentation of the audit report to manually indicate which entries of the audit report are relevant, not relevant, or unknown. Alternatively, the category auditing system 104 may dynamically learn relevance based on detected selections or other interactions by the user with respect to information presented within the audit report.

In addition to training and utilizing the audit generation model 106 to generate a refined search query and extract results from a collection of documents, the category auditing system 104 can additionally train and utilize the audit generation model 106 to selectively identify documents from a larger collection of documents to consider in generating the results.

For example, result feedback (described in further detail below) may be used to further expand or contract a collection of documents to broaden or narrow a search of relevant documents.

As further shown in FIG. 1, the server device(s) 102 may include a topic visualization system 116. In one or more embodiments, the topic visualization system 116 serves as an extension to features and functionalities described above in connection with the category auditing system 104. Alternatively, in one or more embodiments, the topic visualization system 116 is a stand-alone system that collects documents, evaluates documents, and generates a graphical representation independent from the category auditing system. Nevertheless, it will be understood that the topic visualization system 116 may utilize any of the features and functionality discussed herein in connection with the category auditing system 104 in connection with generating and presenting a graphical representation of topic sentiment metrics with respect to a corresponding entity.

As mentioned above, and as shown in FIG. 1, the topic visualization system 116 includes a topic assignment manager 118. Upon receiving or otherwise obtaining a collection of documents 114 associated with an identified entity (or multiple entities), the topic assignment manager 118 may associate the documents 114 with any number of topics. In particular, where a document associated with an entity discusses a particular topic, the topic assignment manager 118 can tag the document with metadata associated with the topic.

In one or more embodiments, the topic assignment manager 118 associates a given document with one or multiple topics. Indeed, the topic assignment manager 118 may tag metadata for any number of topics with a corresponding document file. For example, where a document includes unstructured data (e.g., unstructured text), such as a paragraph or multiple paragraphs within the same document, the topic assignment manager 118 can tag the document with each of a plurality of topics that are references anywhere within the document.

The topic assignment manager 118 can associate the documents with corresponding topics in a variety of ways. For example, the topic assignment manager 118 can simply tag the documents based on mentions or explicit use of specific keywords or phrases that the topic assignment manager 118 has been trained to identify. For instance, in one or more embodiments, an individual or organization may identify any number of relevant topics for an entity and cause the topic assignment manager 118 to scan a collection of documents and tag each document that uses a particular word or phrase associated with the topic.

In one or more embodiments, the topic assignment manager 118 employs a natural language processing (NLP) engine trained to parse free-form text and determine whether the text references corresponding topics. This may involve parsing the text to identify explicit mentions of the topic(s) as well as implicit mentions (e.g., as determined by the NLP model).

In one or more embodiments, the topic assignment manager 118 tags the documents with one or multiple topics in addition to one or more categories within which the topics may belong. For example, in one or more embodiments, the topic assignment manager 118 determines or receives a set of categories and/or topics and effectively groups the documents within the respective topics and categories based on the identified mentions or references to the topics within the text portion of the documents. As an example, and as will be discussed in further detail below, where a document references a “rude manager,” the topic assignment manager 118 may tag the document with first metadata indicating a topic of “bad manager” as well as second metadata indicating a broader topic or category of “bad customer service.” The topic assignment manager 118 may additionally go a level further and add another category of “customer service” encompassing of “bad customer service,” “good customer service” and any additional sub-categories or topics that fall within the respective categories. In one or more embodiments, the topic assignment manager 118 tags the document with each of the relevant topics and associated categories.

As noted above, the topic assignment manager 118 may identify particular topics based on a set of pre-defined topics and/or based on identified topics based on an analysis of the documents. For example, in one or more embodiments, the topic assignment manager 118 may receive a set of pre-defined topics and/or categories that an owner of a business, brand, or other entity may want to analyze with respect to the identified entity. Alternatively, in one or more embodiments, the topic assignment manager 118 may identify topics based on an NLP analysis of the documents trained to identify any number of topics discussed based simply on the text contained within the documents themselves.

In one or more embodiments, the topic assignment manager 118 selectively identifies a set of topics from a plurality of topics representative of all topics identified within the respective documents. For example, in one or more embodiments, the topic assignment manager 118 identifies a set of topics including a subset of topics that are mentioned or referenced more frequently within the collection of documents than other topics. In one or more embodiments, the topic assignment manager 118 identifies a set of topics based on a selection of the set of topics from the plurality of identified topics based on domain knowledge or other considerations. In one or more embodiments, the topic assignment manager 118 identifies the set of topics based on further analysis of sentiment metrics, as discussed in further detail below.

As shown in FIG. 1, the topic visualization system 116 includes an importance model 120. The importance model 120 may include any model (e.g., algorithms, machine learning models) trained to determine a metric of importance for a given topic based on mentions of the topic within a collection of documents. In one or more embodiments, the importance model 120 determines a metric of importance for a topic based on a frequency with which the topic is mentioned relative to other topics from the set of topics. For example, the importance model 120 may associate a topic with a high value of importance if the topic is discussed more frequently than other topics from the plurality of topics (or a selectively identified set of topics) mentioned within the collection of documents.

In one or more embodiments, the importance model 120 considers importance of a given topic to an individual that mentions the topic within one or more documents. For example, the importance model 120 may consider other comments or documents associated with a user and attribute a high measure of importance to a given topic if the individual mentions the topic with a higher level of frequency relative to other topics within the same document or across multiple documents. Accordingly, in one or more embodiments, the importance model 120 attributes different levels of importance to specific topics based on the individual user and a corresponding set of documents that are associated with the individual user.

The importance model 120 calculate the value of importance for a given topic in a variety of ways. In one or more embodiments, the importance model 120 associates a metric of importance to the topic for a given document. For example, the importance model 120 may associate a metric of importance for each topic mentioned within a specific document. In other implementations, the importance model 120 may simply associate a metric of importance to a document based on the topics discussed therein. In one or more embodiments, the importance model 120 determines a metric of importance for a topic based on a cumulation of mentions across the collection of documents.

In accordance with one or more embodiments described above, in one or more embodiments, the importance model 120 determines a metric of importance by identifying a set of topics from a plurality of topics discussed within the collection of documents. The importance model 120 can further rank the set of topics based on a frequency with which the respective topics are discussed with the collection of documents (e.g., frequency within the collection of documents generally, frequency among individuals within sets of documents associated with the respective individuals). The importance model 120 can further calculate a metric for each topic from the set of topics based on a magnitude with which the topic is discussed relative to other topics within the set of topics.

The importance model 120 may be trained and/or refined in a variety of ways. In one or more embodiments, the importance model 120 is trained using the category auditing system 104. For example, in one or more embodiments, the category auditing system 104 provides an indication of importance based on a machine learning model and enables a user of a client device 112 to provide further input to be provided as feedback to the importance model 120 in refining one or more algorithms used by the importance model 120 to determine importance metrics.

As further shown in FIG. 1, the topic visualization system 116 includes an impact model 122. The impact model 122 may include any model (e.g., algorithms, machine learning models) trained to determine a metric of impact for a corresponding topic. In one or more embodiments, the determined impact is a function of change and a resulting outcome of implementing the change. For example, in one or more embodiments, the impact may refer to a cost associated with changing a policy, hiring an employee, or otherwise changing some aspect of an entity (e.g., a business, organization, brand, etc.) compared to a measure of profitability or increased revenue that the associated change would cause. As an illustrative example, in one or more embodiments, the impact model 122 determines an impact metric based on a ratio of cost and profitability.

In one or more embodiments, the impact model 122 determines an estimated cost associated with implementing a change that would solve a problem or otherwise address an identified topic. The impact model 122 may then determine an estimated benefit associated with solving the problem or otherwise implementing the change. In one or more embodiments, the impact model 122 calculates a benefit to cost ratio based on a comparison of the determined estimated cost and estimated benefit. In one or more embodiments, the impact model 122 determines the impact metric as a function of the calculated ratio.

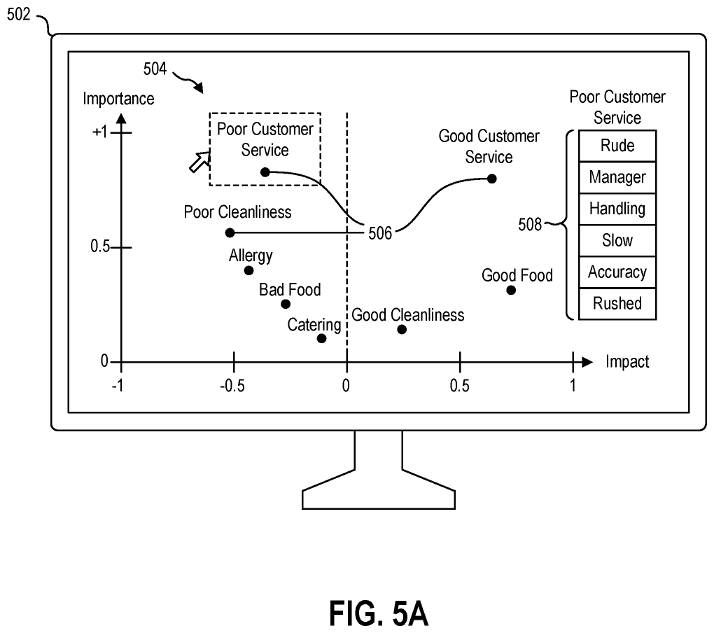

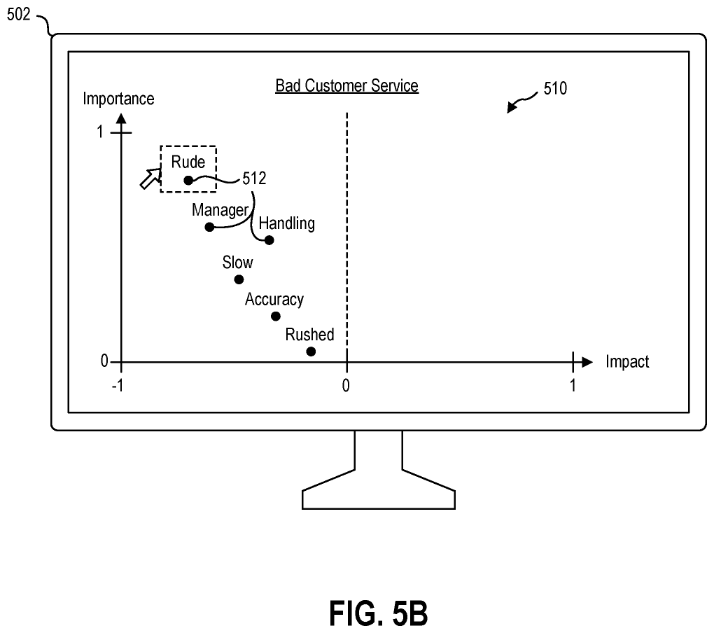

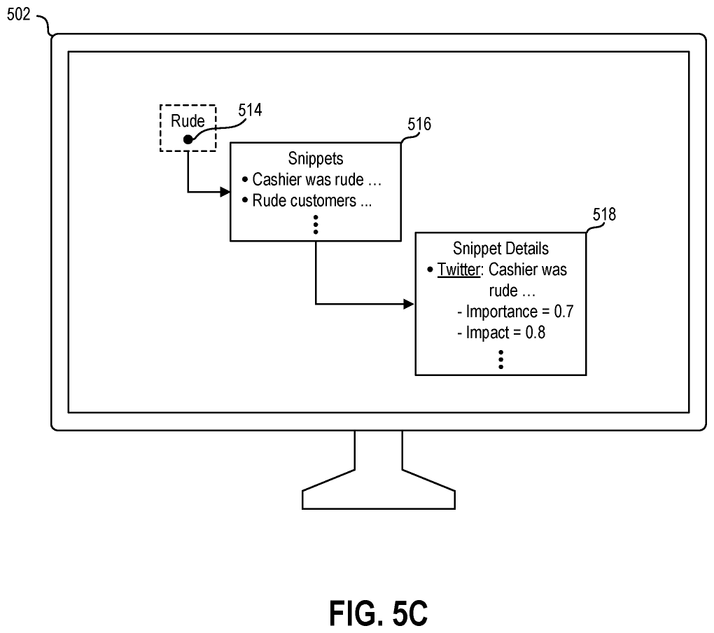

As further shown in FIG. 1, the topic visualization system 116 includes a visualization engine 124. As will be discussed in further detail below, the visualization engine 124 can generate and present a graphical representation of a set of identified topics and their relative importance and impact for an associate entity. In particular, the visualization engine 124 can provide a visual presentation showing an identified set of topics (e.g., a subset of topics determined to be most relevant to the identified entity) and provide interactive features that enable a user of the client device 112 to view additional information about each of the topics presented via the graphical representation. Additional information in connection with generating and presenting the graphical representation is discussed in further detail below in connection with FIGS. 5A-7.

Each of the category auditing system 104 and the topic visualization system may have access to a data storage 126 including data thereon that enables the respective systems 104, 116 to provide features and functionalities described herein. For example, as shown in FIG. 1, the data storage 126 may include model data 128, referring to any data used by the audit generation model 106, importance model 120, and/or impact model 122. As another example, the data storage 126 may include document data 130 include any text, images, or other content that makes up the collection of documents 114. The document data 130 may additionally include any metadata of the documents 114 (e.g., tagged metadata indicting topics, categories, importance, impact, etc.).

FIG. 2 illustrates an example implementation of the audit generation model 106 to generate an audit report based on a collection of documents and a search query and further in view of result feedback receiving by the category auditing system 104. As shown in FIG. 2, the category auditing system 104 provides inputs to the audit generation model 106 including a document collection 202 and query inputs 204. As mentioned above, the document collection 202 may include any number of documents from multiple platforms or sources. In addition, the query inputs 204 may include one or more user-provided inputs including keywords or categories provided to the category auditing system 104 by a client device.

As shown in FIG. 2, the audit generation model 106 may include a number of components 206-212 for generating and providing an audit report 214 to the client device 112. For example, the audit generation model 106 may include a document selection manager 206. The document selection manager 206 may identify or otherwise obtain the collection of documents from a specified source. For example, in one or more embodiments, the query inputs 204 or other input provided by the client device 112 may include an indication of one or more specific platforms or social networks from which to obtain the documents. Accordingly, the document selection manager 206 may identify a subset of all available documents in accordance with one or more inputs provided by the client device.

In one or more embodiments, the document selection manager 206 further narrows the document collection 202 by selectively identifying a subset of documents based on one or more of the query inputs 204. For example, where the query inputs 204 include a keyword or selected category, the document selection manager 206 may perform a simple keyword filter algorithm to discard or exclude any number of irrelevant documents without performing any additional analysis. As another example, and as will be discussed further below, the document selection manger 206 may filter documents based on a selected platform (e.g., news platform, social networking platform) or document source. Accordingly, in one or more embodiments, the document selection manager 206 performs an initial filtering process to significantly narrow the document collection 202 to a relevant subset prior to applying one or more additional algorithms or models included within the audit generation model 106 to the subset of documents. In this way, the document selection manager 206 may significantly reduce processing resources needed when applying the audit generation model 106 to the document collection 202.

As shown in FIG. 2, the audit generation model 106 additionally includes a category query manager 208. The category query manager 208 may generate a refined search query based on the query inputs 204 in addition to result feedback 216 based on historical data associated with interactions and other data collected in connection with previously generated audit reports. For example, the category query manager 208 may recognize a trend (e.g., for a specific user, or across multiple users performing search queries) of terms, phrases, or certain topics that affect whether a particular document or portion of a document is relevant to a search query (e.g., a category specified within a search query). In one or more embodiments, the category query manager 208 generates or otherwise identifies one or more latent variables to modify a search query or otherwise generate a refined search query for more effectively analyzing and identifying relevant documents (e.g., from the narrowed subset of the document collection 202). In accordance with various examples described herein, the latent variables may include specific terms to include or exclude and/or may include constraints to apply when analyzing documents and/or terms of a search query.

As further shown in FIG. 2, the audit generation model 106 includes a result extraction manager 210. The result extraction manager 210 can receive as input the refined search query in addition to historical data associated with previously generated audit reports (e.g., previously received result feedback 216) to train any number of algorithms to analyze or parse a set of documents to identify one or more relevant documents and/or identify portions of the documents that are relevant to the refined search query.

The result extraction manager 210 may utilize any number of models or algorithms. For example, in one or more embodiments, the result extraction manager 210 implements or utilizes a machine learning model or algorithm(s) trained to identify or extract snippets of text (e.g., a single snippet or multiple snippets from the same document) from a set of documents based on an analysis of a search query (e.g., the refined search query) and content included within the document(s). The result extraction manager 210 may utilize any number of methods or techniques to analyze the documents in view of the search query including natural language processing, capture concepts, text or phrase classification, matching, vectorization, tracking, augmentation, or other forms of analysis.

As further shown, the audit generation model 106 includes a report generator 212 for generating the audit report 214. For example, the report generator 212 may compile any number of relevant results (e.g., all of the results, a subset of results) and compile the relevant results within a file or document to provide to the client device 112 for presentation via a graphical user interface of the client device 112. The report generator 212 can include all relevant results or snippets within the audit report 214. Alternatively, the report generator 212 can include a random sample or a predetermined number of the most relevant results within the audit report 214 based on the analysis performed by the result extraction manager 210.

The audit report 214 may include any information associated with the relevant results. For example, the audit report 214 may include extracted snippets from source documents (e.g., rather than including entire documents within the report). In addition, the audit report 214 may include an identification of the platform (e.g., social networking platform), an identification of the individual (e.g., a username) who shared or uploaded the file. The audit report 214 may include an indication of relevance as determined by the result extraction manager 210. Indeed, the audit report 214 may include any information associated with the results or documents within the audit report 214.

In addition to various types of information about the specific results and/or associated source documents, the audit report 214 may additionally include information about how the query results were generated. For instance, the audit report 214 may include an indication of how an original search query was modified to generate a refined search query. The audit report 214 may additionally include a history of interactions or user selections detected leading up to generation of the audit report 214. In one or more implementations, the audit report 214 includes operators, terms, weighted values, categories, or other data used by an algorithm or machine learning model in generating results of the audit report 214. In one or more embodiments, the audit report 214 includes one or more suggested modifications or related combinations of terms, words, or other search elements that may be better equipped to produce relevant results that align with the original search query.

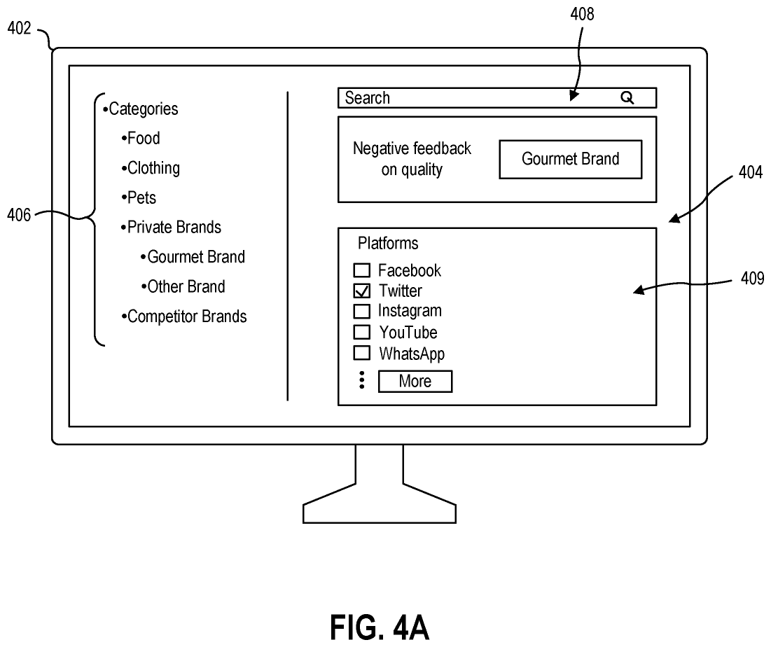

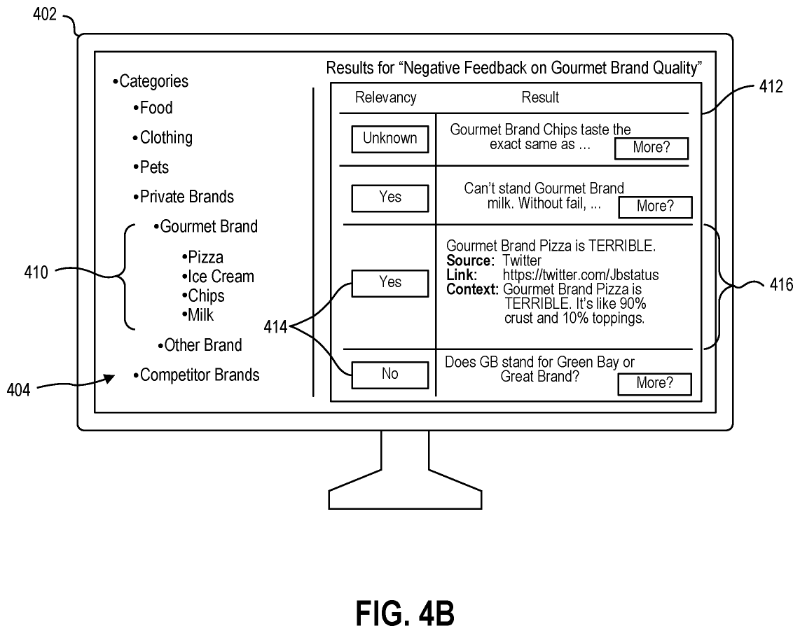

While the audit report 214 may include any number of the example types of information mentioned above, the client device 212 may include a display of some or all of the information included within the audit report 214. For instance, the client device 112 may provide a display of a portion of the information included within the audit report 214 such as a list of relevant results and a display of extracted snippets of source documents, the client device 212 may hide or collapse certain portions of the information in example presentations of the audit report 214. Indeed, as will be discussed below in connection with FIG. 4B, a user of the client device 112 may interact with a graphical user interface to obtain additional information from the audit report 214 (e.g., by selecting or otherwise interacting with specific results from the audit report 214).

As mentioned above, and as will be discussed further, the audit report 214 can additionally include or otherwise provide interactive functionality that enables a user of the client device 112 to interact with the audit report 214 to generate result feedback 216. For example, the audit report 214, when presented via a graphical user interface of the client device 112, may include selectable options to enable a user of the client device 112 to interact with specific entries of the audit report 214 and manually indicate whether a particular entry is relevant to the search query. The user may select any number of entries to indicate classifications for the results including, for example, “relevant,” “not relevant,” “unknown” or other classification.

In addition to manual feedback, the result feedback 216 may include tracked feedback about the audit report 214. For example, the category auditing system 104 may track or otherwise observe interactions with one or more entries of the audit report 214 and determine, based on the observer interactions (or lack of interactions), that relevancy or non-relevancy of results included within the audit report 214. Examples of tracked activity may include views, downloaded cookies, clicks on specific entries or links, duration of time that a certain entry has been opened or viewed, etc.

As shown in FIG. 2, the result feedback 216 may be used to further refine or train one or more processes performed using the audit generation model 106. For example, the result feedback 216 may be used to refine the process performed by the category query manager 208 to determine a refined search query. Indeed, the result feedback 216 may indicate that certain search terms may have a high or low correlation with relevant or non-relevant result feedback. Accordingly, the category auditing system 104 may associate latent variables including one or more additional search terms that should be added to search queries associated with one or more associated categories or topics.

In addition to indicating additional terms that may further narrow or broaden the scope of a document search, the category auditing system 104 may additionally identify one or more negative correlations. For example, audit generation model 106 may learn that where a search query includes a first term, results often include a secondary term that significantly changes the meaning of a result and renders the result less related to other results that have a high relevance with the topic of the search query. Accordingly, the audit generation model 106 may learn to exclude, minimize, or otherwise discount the second term when query inputs 204 associated with the first term are received.

In one or more embodiments, upon receiving the result feedback 216, the audit generation model 106 can learn that a set of results includes multiple subcategories of results that have limited relevance. For example, where a search query includes a keyword of “pizza” and “quality,” the results from one or multiple audit reports 214 may initially include results about “cheese” and “meat,” where the results about cheese relate to a first type of pizza while the results about meat relate to a second type of pizza. Based on this identified trend or distinction (e.g., learned trend or distinction), the category auditing system 104 may provide one or more tools to an end-user to enable the user to further refine a search query. As an example, upon receiving a search query about pizza (or any time after the audit generation model 106 learns the category distinction), the category auditing system 104 may provide one or more selectable options for a user to indicate a subcategory. This provides a more accurate search query, which enables the category auditing system 104 to search a smaller quantity of documents when generating the refined search query and analyzing a subset of a larger collection of documents to extract search results.

In addition to utilizing the result feedback 216 to refine the process performed by the category query manager 208 to generate the refined search query, the result feedback 216 may additionally be used by the result extraction manager 210 to more accurately extract results from the documents over time. Indeed, the result feedback 216 may be used to hone or otherwise fine-tune algorithms or machine learning model(s) used by the result extraction manager 210 to selectively identify portions of documents to include within an audit report 214.

In one or more embodiments, the audit generation model 106 may utilize the result feedback 216 to facilitate creation of a refined audit report 218. For example, a user of the client device 112 may provide an indication of whether the data from the audit report 214 is satisfactory in view of additional training and refinement of the audit generation model 106. As shown in FIG. 2, the client device 112 may generate a refined audit report 218 based on the updated training and refinement of the model(s). In one or more embodiments, the refined audit report is presented as a graphical representation showing importance and impact of topics related to an identified entity.

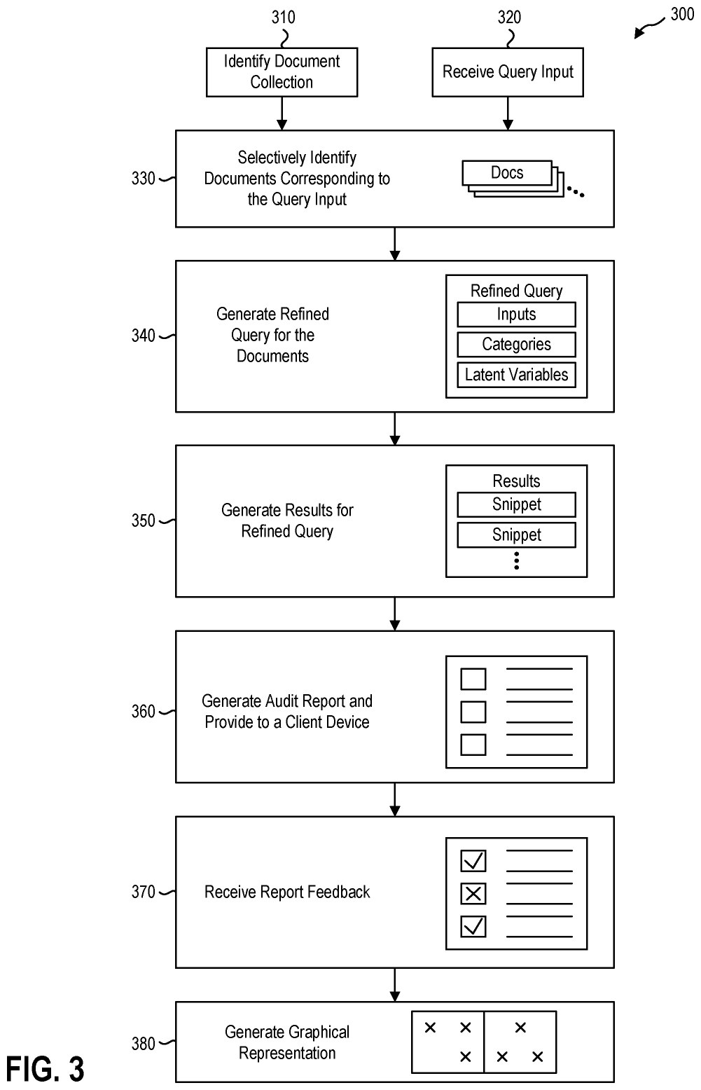

FIG. 3 illustrates an example embodiment for implementing an audit generation model to generate and provide an audit report to a client device in accordance with one or more embodiments described herein. In particular, FIG. 3 illustrates a series of acts that the category audit system 104 may perform in generating an audit report as well as fine tuning a model to more accurately and more efficiently identify results including portions of documents to include within subsequently generated audit reports.

As shown in FIG. 3, the category audit system 104 may perform an act 310 of identifying a document collection. The document collection may include any number of documents accessible to the category audit system 104. In accordance with one or more embodiments described above, the documents may include documents from a selected (e.g., user-selected) platform or other storage space(s) of documents accessible to the category audit system 104.

The category audit system 104 may additionally perform an act 320 of receiving a query input. The query input may include free-form text that the category audit system 104 parses to limit the collection of documents. The query may additionally include one or more selected categories or topics presented to a user providing the search query. For example, based on training of the audit generation model 106, the category audit system 104 may provide one or more categories and sub-categories determined to be relevant to a particular topic. As mentioned above, the query may include other search elements, such as images, portions of images, videos, audio files, or other elements that may be used to search the collection of documents.

In one or more embodiments, the category audit system 104 presents a list of available categories or topics that the category audit system 104 has been tasked with monitoring by a client. For example, an individual or business may request a predefined number of topics or categories of interest that the category audit system 104 can develop and train the audit generation model 106 to consider in generating the audit report. The category audit system 104 may present any number of categories or selectable topics via a graphical user interface of a client device. This is discussed by way of example below in connection with FIG. 4A.

As shown in FIG. 3, the category audit system 104 can perform an act 330 of selectively identifying documents corresponding to the query input. In particular, the category audit system 104 can selectively narrow the collection of documents to a subset of documents prior to performing additional processing on the collection of documents. This may include identifying a subset of documents based on one or more search elements from the search query and/or based on a selected document source or platform. As an example, in one or more embodiments, the category audit system 104 selectively identifies documents by filtering the collection of documents based on one or multiple keywords included within the received query input. In this way, the category audit system 104 can perform an initial simple filtering that utilizes fewer processing resources than other models employed by the category audit system 104 in generating a refined query and/or analyzing content of select documents.

The category audit system 104 can additionally perform an act 340 of generating a refined query for the documents. As discussed above, this may include adding one or more keywords to keywords identified from within the original search query. In addition, this may include identifying one or more categories which the audit generation model 106 is trained to analyze. In one or more embodiments, the category audit system 104 identified one or more latent variables including weights to apply to certain terms and/or terms to add or subtract from a refined search query that more accurately enable the category audit system 104 to identify relevant results within the selected subset of documents.

The category audit system 104 can additionally perform an act 350 of generating results for the refined query. In particular, the category audit system 104 can apply the refined query and a machine learning model to the identified subset of documents to identify snippets or other results from within the documents to include within an audit report. The category audit system 104 can identify any number of snippets or results from the collection of documents.

The category audit system 104 can additionally perform an act 360 of generating an audit report and provide the audit report to a client device. In generating the audit report, the category audit system 104 can identify any number of the results to include within the audit report. In one or more embodiments, the category audit system 104 identifies the most relevant results (e.g., predicts the most relevant results based on algorithms or instructions of the audit generation model 106). Alternatively, in one or more embodiments, the category audit system 104 identifies a random or pseudorandom set of results to include within the audit. By identifying random result or at least including some results of unknown relevance, the category audit system 104 facilitates receiving feedback to train the audit generation model 106 to more accurately or efficiently analyze a set of documents to identify relevant results.

As shown in FIG. 3, the category audit system 104 can perform an act 370 of receiving report feedback. As indicated above, the feedback may include manually selected indicators of relevancy with respect to individual entries of the audit report. In one or more embodiments, the category audit system 104 monitors, tracks, or observes interactions (or lack of interactions) by individuals to further fine-tune the audit generation model 106.

As shown in FIG. 3, the result feedback may be utilized in subsequent instances of selectively identifying documents, generating refined queries, or otherwise utilizing the audit generation model 106 in performing subsequent searches. As an example, the result feedback may be used to more accurately emphasize or discount certain terms or combinations of terms. The category audit system 104 can further utilize the result feedback to identify latent variables that improve upon the accuracy and/or efficiency of the audit generation model 106 (e.g., the category query manager 208) in generating future instances of refined search queries.

As further shown, the result feedback may be utilized in subsequent instances of generating results (e.g., extracting portions of documents) in response to subsequently received query inputs. For example, the category audit system 104 can fine-tune algorithms or models used in analyzing documents and/or applying a refined query to a collection of documents (or subset of documents from a collection of documents) to determine relevant results that correspond to a received query input.

As shown in FIG. 3, the series of acts 300 may additionally include an act 380 of generating a graphical representation showing various topics and associated metrics of importance and impact for an identified entity. In one or more embodiments, the graphical representation is generated based on the audit report.

Referring now to FIG. 4A, this figure illustrates an example graphical user interface presented via a client device in accordance with one or more embodiments. In particular, FIG. 4A illustrates a client device 402, which may refer to an example of the client device 112 described above, and which includes a graphical user interface 404 for presenting information to a user.

FIG. 4A illustrates an example search interface of the category audit system 104 including a listing of categories 406 for which an end-user may have an interest. In particular, the category audit system 104 may identify categories based on prior searches by the user of the client device 402 (or other users of the category audit system 104). The category audit system 104 may additionally identify categories for which a user of the client device 402 has requested the category audit system 104 to audit. Accordingly, the listing of categories 406 shown in FIG. 4A illustrates one example of a listing of categories for which the category audit system 104 has developed and trained an audit generation model 106 to analyze and generate one or more audit reports.

In the illustrated example, the listing of categories 406 includes categories such as food, clothing, pets, private brands, and competitor brands. As shown in FIG. 4A, the listing of categories 406 may include subcategories for one or more of the individual categories. As mentioned above, the category audit system 104 may dynamically determine one or more sub-categories (as well as further layers of sub-categories) based on dynamically received result feedback in connection with certain results from previously generated audit reports (for the user of the client device 402 or for multiple users of any number of client devices). In addition, the client device 402 may further expand any of the categories based on a user selection of a given category.

As mentioned above, FIG. 4A illustrates an example search interface including a search window 408 within which a user may compose or otherwise generate a search query. For example, a user may type “negative feedback on Gourmet Brand quality” indicating a desire to view results or snippets from a plurality of documents associated with negative experiences of customers with products from the Gourmet Brand. In one or more embodiments, a user of the client device 402 simply types or composes the search query using a keyboard or other input device. Alternatively, in one or more embodiments, the listing of categories 406 are selectable, enabling the user of the client device 402 to select a listed category to indicate a topic for the search (e.g., “Gourmet Brand”). Accordingly, the resulting search query may include a fully composed query, a selected query, or a combination of composed text and selected option(s).

In accordance with one or more embodiments described above, the category audit system 104 can generate a refined query including one or more modifications to the typed query and/or latent variables to consider when performing a search of documents. This may include a string of Boolean operators (not shown), instructions for performing a hierarchical analysis of the documents, or simply a refined query including a slightly different combination of words more equipped to product relevant results that align with the original search query typed by the user.

As shown in FIG. 4A, the category audit system 104 can include a listing of available platforms 409 from which to search documents and identify results of the search query. For example, the category audit system 104 may include a list of any number of platforms or sources of documents for which the category audit system 104 has access. A user of the client device 402 can select one or multiple platforms from the listing of available platforms 409 to further narrow or broaden the search of documents across one or multiple platforms. For example, as shown in FIG. 4A, the available platforms 409 may include example platforms such as “Facebook,” “Twitter,” “Instagram,” “YouTube,” and “WhatsApp.” The available platforms 409 may include any number and type of platforms including, by way of example, media platforms, news platforms, content sharing platforms, or any other public or private platform that is accessible to the audit generation model 106.

FIG. 4B illustrates an example presentation of the resulting audit report generated and provided to the client device 402 by the category audit system 104. For example, the category audit system 104 may include a listing of relevant sub-categories 410 associated with the “Gourmet Brand” category or topic identified within the search query. The sub-categories may include additional layers of sub-categories. In addition, a user of the client device 402 may select one or more of the sub-categories to further narrow the search of documents and refine the results presented within the audit report.

As shown in FIG. 4B, the graphical user interface 404 further includes a presentation of the audit report 412 including any number of entries. In the example shown in FIG. 4B, the entries include snippets from specific documents including quoted portions of the documents within the right column of the audit report 412. In addition, each entry includes an indication of relevancy for the specific entry. Example indications of relevancy may include “yes” (indicating that an entry is relevant), “no” (indicating that an entry is not relevant), and “unknown” (indicating unknown relevancy for an entry). An initial display of the audit report 412 may include default designations of relevancy as “unknown” or “N/A,” and may change in response to detecting a user selection of a selectable icon 414 for one or more respective entries.

For example, as shown in FIG. 4B, a user of the client device 402 may select “unknown” for a first entry where the snippet does not provide a clear indication of whether the quality of the Gourmet Brand product is associated with a positive or negative experience. The user may additionally select “yes” for the second and third entries indicating that the results are relevant to negative customer experiences with Gourmet Brand products. Moreover, the user may select “no” for the fourth entry to indicate that the result is not relevant.

As indicated above, the category audit system 104 may utilize each of the selected indications of relevancy to further train or refine an audit generation model in accordance with one or more embodiments described above. For example, the category audit system 104 may provide positive feedback for the second and third entries to indicate types of entries to identify in the future. In addition, the category audit system 104 may provide the negative feedback for the fourth entry to indicate types of entries to not identify in the future. Further, the category audit system 104 may provide the neutral feedback for the first entry to determine any other refinements to the model to more accurately or efficiently identify results.

As further shown in FIG. 4B, the category audit system 104 enables a user of the client device 402 to select and expand one of the entries to view additional information about the result and/or document from which the result was extracted. For example, in response to selecting the third entry of the audit report 412, the category audit system 104 provides (or causes the client device or application on the client device to provide) additional information 416 including the snippet, a source of the snippet (e.g., Twitter), a selectable link to the source document (e.g., a URL), and additional text or context from the document associated with the snippet. This may include an entire post or sentence or paragraph from which the snippet was extracted, providing a user of the client device with additional information about the result.

This expanded view including additional information would similarly be useful to enable the user of the client device 402 to further inform themselves on the relevancy of an entry prior to selecting a “no,” “yes,” or “unknown” indication of relevance. For example, the user could select the first entry to view additional information to accurately determine whether the entry is relevant or not relevant rather than “unknown,” as shown in FIG. 4B.

In accordance with one or more embodiments, the audit report can include additional information, such as an indication of how the query result was produced. This information may be included in the expanded view, which may present additional information from the audit report not initially displayed via a presentation of the audit report 412. The expanded view can display data relating to how the system refined the initial search query, such as displaying one or more modifications to the typed query and/or latent variables that were considered by a machine learning model. This displayed data may include a string of Boolean operators and terms, indications of selections used in performing a hierarchical analysis of the documents, indications of categories considered important and used by a machine learning model, or simply displaying of the refined query, for example that included a slightly different combination of words more equipped to produce relevant results that align with the original search query typed or input by the user.

Additional information will now be discussed in connection with generating and presenting a graphical representation showing importance and impacts of identified topics associated with example entities. For example, FIG. 5A illustrates an example client device 502 having a graphical user interface and displaying an example graphical representation 504 for an example restaurant entity. In this example, the topic visualization system 116 may have collected documents across one or more platforms and analyzed the documents (alone or in cooperation with the category auditing system 104) to determine metrics of importance and impact associated with various topics.

In particular, and as shown in FIG. 5A, the graphical representation 504 generated by the topic visualization system 116 may include topics icons 506 associated with a set of topics that have been identified for the restaurant entity. In one or more embodiments, the topic visualization system 116 identifies a set of topics representative of a subset of a total number of topics identified for a collection of documents. For example, in one or more embodiments, the topic visualization system 116 identifies the topics having at least a threshold metric of importance and/or impact to include within the graphical representation 504. In one or more embodiments, the topic visualization system 116 identifies the set of topics corresponding to the displayed topics icons 506 by selectively identifying a subset of potential topics a threshold distance away from an origin point (at coordinates 0, 0) of the graphical representation.

In one or more embodiments, the topic icons 506 may include topics related to the restaurant entity that, upon analysis of the text from the collection of documents, effect whether an individual is likely to return to the restaurant. By way of example, the topic icons 506 include indicators of topics such as “poor customer service,” “poor cleanliness,” “allergy,” “bad food,” “catering,” “good cleanliness,” “good food,” and “good customer service.”

As shown in FIG. 5A, each of the identified topic icons 506 may be displayed in accordance with impact and importance. For example, the horizontal axis may be representative of an impact while the vertical axis is representative of importance. As shown in FIG. 5A, the metric of impact may range between −1 and +1 while the metric of importance ranges between 0 and +1. Other scales indicating metrics of importance and impact may be used. For example, in one or more embodiments, the metrics of importance and impact may be expressed based on a number of instances that a particular topic is references and/or based on a specific benefit or ratio of cost to benefit that can be achieved by implementing actions associated with a specific topic.

It will be noted that certain topics are associated with significantly higher importance and/or impact than other topics. For example, analysis of the text of the collection of documents and determination of the sentiment metrics may show that poor customer service and good customer service are both important topics for a customer base of the restaurant entity. In addition, while less important, topics such as poor cleanliness, allergy considerations, and good food have high metrics of impact. As a further example, topics such as catering and good cleanliness may have relatively low importance and impact to the customers. In each of these cases, a user of the client device 502 may understand how a customer base is likely to react to changes or implementation of certain policies with respect to the restaurant. For instance, an owner of the restaurant may choose to focus additional efforts in customer service rather than building out a more robust catering element of the restaurant.

While FIG. 5A is discussed in terms of topics and topic icons 506, it will be understood that these example topics may refer specifically to categories having associated topics (e.g., sub-categories). Alternatively, in one or more embodiments, the topic icons 506 may refer to sub-categories of a higher level category.

As shown in FIG. 5A, the topic visualization system 116 may enable a user of the client device 502 to interact with and select one or more of the topic icons 506. For instance, in this example, a user of the client device 502 may tap, click on, or otherwise select the “poor customer service” icon to view a listing of sub-icons 508 associated with poor customer service. For example, in response to detecting a selection of the poor customer service icon, the topic visualization system 116 can generate and provide the listing of sub-icons 508 including a variety of sub-topics such as “rude,” “manager,” “handling,” “slow,” “accuracy,” and “rushed” related to different sub-topics of the higher level topic of “poor customer service.” In accordance with one or more embodiments described herein, the topic visualization system 116 may be aware of one or more additional sub-topics, but selectively display only the listing of sub-topics 508 based on the identified sub-topics having a threshold impact and/or threshold metric or a threshold number of mentions within a relevant collection of documents.

In one or more embodiments, the topic visualization system 116 enables a user of the client device 502 to drill down and view information associated with additional sub-topics of a given category. For example, in response to selecting the poor customer service topic icon, the topic visualization system 116 may cause the client device 502 to present a drilled down view 510 of the graphical representation showing the sub-topics of the poor customer service topic and associated metrics of importance.

In particular, as shown in FIG. 5B, in response to detecting a selection of the poor customer service topic icon shown in FIG. 5A, the topic visualization system 116 can provide a plurality of sub-topic icons 512 showing the respective sub-topics that were previously determined to be related sub-topics to the poor customer service category. By way of example, this may include showing sub-topic icons associated with sub-topics such as “rude,” “manager,” “handling,” “slow,” “accuracy,” and “rushed.” Each of these sub-topics may refer to specific behaviors or aspects of the poor customer service that individuals experienced upon visiting a restaurant of the relevant restaurant entity.

As noted above, this drilled down view provides additional context with respect to specific topics. For example, in the context of poor customer service, a user of the client device 502 can see that “rude” customer service or a bad “manager” are much more important and impactful than topics such as “rushed” customer service or poor “accuracy” of customer orders. In this way, an owner of the restaurant entity may have additional actionable information in how best to address the topic of poor customer service that was mentioned in a high number of the collection of documents.

In one or more embodiments, the topic visualization system 116 enables a user of the client device 502 to further drill down into the respective sub-topics. For example, FIG. 5C shows an example display responsive to a user selection of the rude sub-topic icon 514. Based on the selected sub-topic icon 514, the topic visualization system 116 can provide a listing of snippets 516 of documents having a metadata topic tag of “rude” associated therewith. The listing of snippets 516 may include portions of text from the documents showing the context of how the term “rude” was used with respect to the restaurant entity (e.g., “cashier was rude,” “rude customers”).

In one or more embodiments, the topic visualization system 116 can further show snippet details 518 showing information about the corresponding snippets and/or source documents. For example, as shown in FIG. 5C, the topic visualization system 116 can provide platform information associated with the respective document snippets. For instance, the topic visualization system 116 can show that the “cashier was rude” comment originated from a first social media platform (e.g., Twitter). The topic visualization system 116 may also provide additional information about the document, such as the indicated metrics of importance or impact that were associated to the specific document (or document snippet).

In one or more embodiments, the topic visualization system 116 enables a user of the client device 502 to navigate to the source document itself and engage with the individual associated with the source document. In this case, the user of the client deice 502 may communicate with the author of the document via the identified communication platform to learn more about the specific experience and/or provide further incentives to return to the restaurant. In some instances, the topic visualization system 116 simply enables the user of the client device 502 to learn more about the indicated topic.

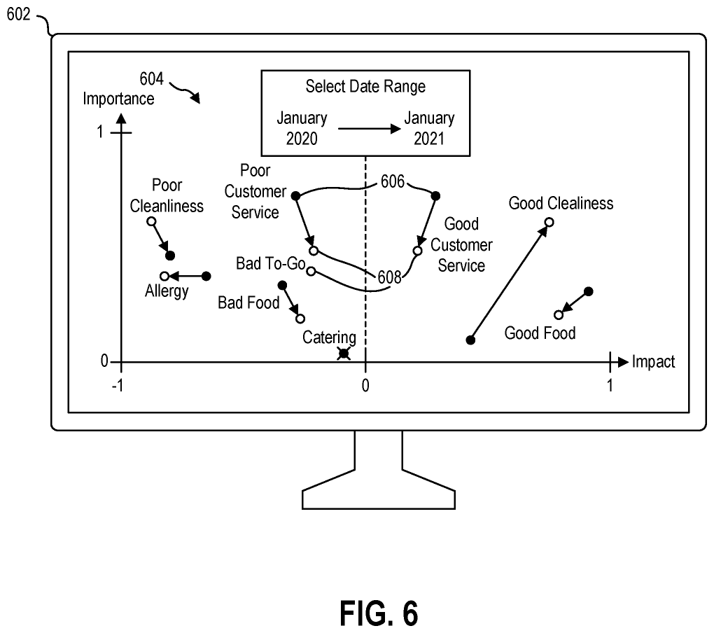

Referring now to FIG. 6, a client device 602 may provide a dynamic view 604 of the graphical representation showing the various topics in reference to the identified entity. In particular, FIG. 6 illustrates an example implementation in which a dynamic view 604 shows how various topics change in importance and impact over a period of time (e.g., a selected period of time between January 2020 and January 2021).

As shown in FIG. 6, the dynamic view can include a first set of topic icons 606 corresponding to a first selected date (e.g., January 2020) corresponding to a collection of documents collected and analyzed at around the first selected date. As further shown, the dynamic view 604 can include a second set of topic icons 608 corresponding to a second selected date (e.g., January 2021) corresponding to a collection of documents collected and analyzed over a different period of time. For example, the second set of topic icons 608 may correspond to a new set of documents that are collected between the first date and the second date. Alternatively, the second set of topic icons 608 may correspond to a combination of the first collection of documents associated with the first set of topic icons 606 and additional collected documents leading up to the second selected date.

As shown in the dynamic view 604, each of importance and impact metrics may change for the various topics based on additional documents collected over time. The dynamic view 604 may provide an indication of changing preferences of individuals over time associated with the documents (e.g., where “to-go” options may become more prevalent during 2020 or where “good cleanliness” is associated with a higher metric of impact and importance over the same period of time). In contrast, sentiment metrics for one or more topics may fall below a threshold (e.g., such as for the “catering” topic) and may no longer be included within the visualization for the second selected date.

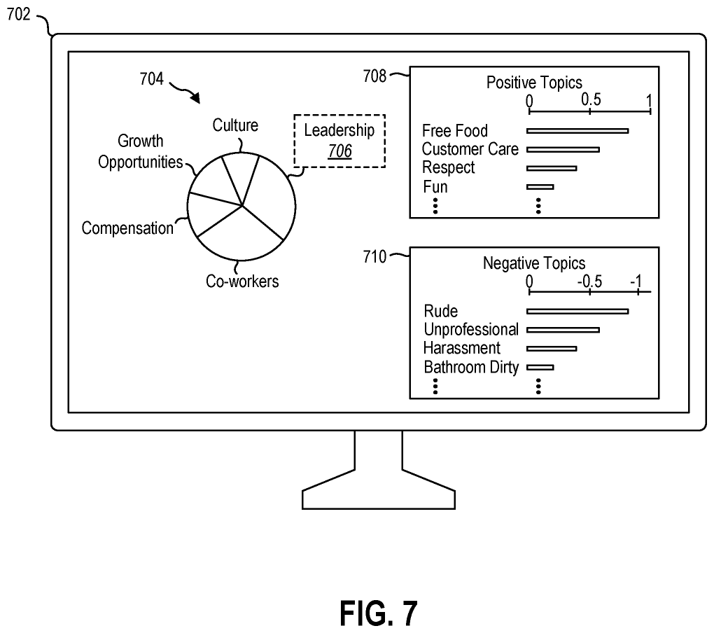

FIG. 7 shows a further example implementation of a graphical representation showing sentiment metrics for topics associated with another example entity. In particular, FIG. 7 shows a graphical representation showing topics associated with an identified employment entity. For example, FIG. 7 shows another client device 702 displaying another graphical representation 704 generated by a topic visualization system 116 in accordance with one or more embodiments. In this example, the graphical representation 704 shows a pie chart indicating selectable icons indicating categories associated with the employment entity (and related to working for or otherwise being employed by the entity). Example categories in this visualization include “leadership,” “co-workers,” “compensation,” “growth opportunities,” and “culture” reflective of topics within the corresponding categories that were referenced within a collection of documents.

Similar to one or more embodiments described above, the visualization of the graphical representation includes selectable icons for the corresponding categories that enables a user of the client device 702 to drill down and view additional details with respect to the specific categories/topics. In this example, a user can select a first category icon 706 and, responsive to the selection, the topic visualization system 116 can provide a presentation of positive sub-categories 708 (or topics 708) and negative sub-categories 710 (or topics 710). In this example, the positive sub-categories 708 include topics such as “free-food,” “customer care,” “respect,” and “fun” while the negative sub-categories 710 include topics such as “rude,” “unprofessional,” “harassment,” and “bathroom duty.” Each of these topics may include corresponding metric visualization indicating a measure of sentiment metrics. In one or more embodiments, the metric may refer to a number of mentions of the corresponding topics within associated documents. In one or more embodiments, the metric may be representative of an importance and impact metric, similar to one or more embodiments described above.

It will be understood that while one or more embodiments described herein referred to specific example graphical representations in which topics associated with employment and restaurant entities were illustrated. It will be understood that other types of entities, such as brands, products, businesses, influencers, and other organizations may be used as an entity for identifying documents and associated topics referenced therein. For example, the representation may include a graph showing sentiment metrics with respect to features/functionality of a particular product or reception of specific topics that are discussed or referenced by influencers when publishing content. Moreover, in one or more embodiments, the identified entity may refer to a collection of multiple entities, such as a set of multiple businesses, multiple product, or any other identified entity that can be associated with a collection of documents and having topics associated therewith.

Many of the features and functionalities described herein are described in connection with specific examples or embodiments. It will be understood that different features and acts described in connection with a specific example or implementation may apply to other examples or implementations. Moreover, it will be understood that alternative implementations may omit, add to, reorder, and/or modify any of the acts or series of acts described herein. In addition, the category audit system 104 may perform acts described herein as part of a method, Alternatively, the category audit system 104 may implement a non-transitory computer readable medium including instructions that, when executed by one or more processors, cause a computing device (e.g., a server device) to perform features and functionality described herein. In still further embodiments, a system can perform the features and functionality described herein.

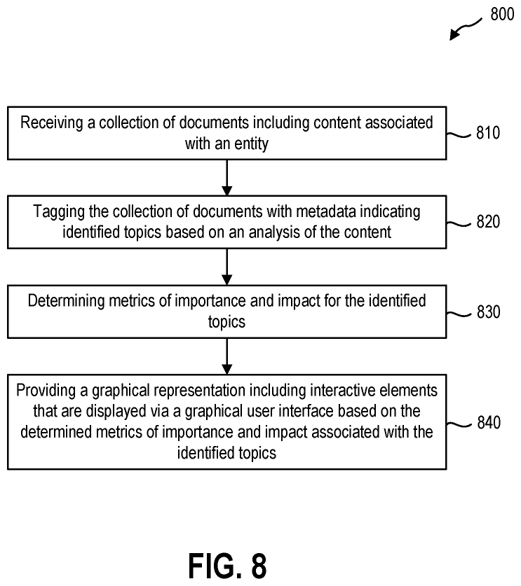

Turning now to FIG. 8, this figure illustrates an example flowchart including a series of acts for generating and presenting a graphical representation of topics and associated sentiment metrics corresponding to an entity. While FIG. 8 illustrates acts according to one or more embodiments, alternative embodiment may omit, add to, reorder, and/or modify any of the acts shown in FIG. 8. The acts of FIG. 8 may be performed as part of a method. Alternative, a non-transitory computer-readable medium can include instructions that, when executed by one or more processors, causes a computing device (or multiple devices) to perform the acts of FIG. 8. In still further embodiments, a system can perform the acts of FIG. 8.

As shown in FIG. 8, the series of acts 800 may include an act 810 of receiving a collection of documents including text content associated with an entity. For example, in one or more embodiments, the act 810 includes receiving a collection of documents including text content associated with one or more entities. In one or more embodiments, receiving the collection of documents includes receiving a first set of documents from a first communication platform and a second set of documents from a second communication platform.

In one or more embodiments, the collection of documents includes one or more of a plurality of digital content items shared via a social networking system, a plurality of user-composed social networking posts shared via the social networking system, or a plurality of digital content items shared across a plurality of social networking systems. In one or more embodiments, receiving the collection of documents associated with the one or more entities includes identifying a set of documents that reference one or more of an organization, a product, or a brand associated with the one or more entities.

As further shown, the series of acts 800 may include an act 820 of tagging the collection of documents with metadata indicating identified topics based on an analysis of the text content. For example, in one or more embodiments, the act 830 includes tagging each document from the collection of documents with metadata indicating one or more identified categories of the document based on an analysis of the text content included within the document. In one or more embodiments, tagging each document includes adding metadata to a document file for each of any number of identified topics referenced by text content included within the document.

As further shown, the series of acts 800 may include an act 830 of determining metrics of importance and impact for the identified topics. For example, in one or more embodiments, the act 830 includes determining, for a set of topics, metrics of importance and metrics of impact associated with the one or more entities.

In one or more embodiments, the series of acts includes identifying the set of topics from a plurality of topics associated with one or more documents from the collection of documents where the set of topics includes a subset of topics from the plurality of topics. In one or more embodiments, the subset of topics are identified based on the subset of topics corresponding to each topic from the subset of topics being associated with a threshold number of tagged documents from the collection of documents. In one or more embodiments, the subset of topics are identified based on metrics of importance and metrics of impact for the subset of topics being higher than one or more threshold metrics of importance and impact.

In one or more embodiments, determining the metrics of importance for the set of topics includes identifying the set of topics from a plurality of topics discussed within the collection of documents, ranking the set of topics based on a frequency with which the respective topics are discussed within the collection of documents, and calculating a metric for each topic from the set of topics based on a magnitude with which the topic is discussed relative to other topics within the set of topics. In one or more embodiments, determining the metrics of impact for the set of topics includes, for each topic from the set of topics, determining an estimated cost associated with solving a problem associated with the topic, determining an estimated benefit associated with solving the problem associated with the topic, and calculating a benefit to cost ratio based on a comparison of the determined estimated benefit and the determined estimated cost.

As further shown, the series of acts 800 may include an act 840 of providing a graphical representation including interactive elements that are displayed via a graphical user interface based on the determined metrics of importance and impact associated with the identified topics. For example, in one or more embodiments, the act 840 includes providing a graphical representation including a plurality of interactive elements to be displayed on a graphical user interface based on a combination of the determined metrics of importance and the metrics of impact associated with respective topics from the set of topics.

In one or more embodiments, the text content includes unstructured text (or other types of unstructured data). Further, the series of acts 800 may include applying a machine learning model to each document from the collection of documents, the machine learning model being trained to analyze the unstructured text and output at least one identified topic of the document.

In one or more embodiments, the series of acts 800 includes identifying one or more categories including discrete groupings of topics from the set of topics. In this example, providing the graphical representation may include displaying an interactive element for each category of the one or more categories based on a combination of metrics of importance and metrics of impact for topics included within the category. In one or more embodiments, the series of acts 800 includes detecting a selection of a first interactive element from the plurality of interactive elements, the first interactive element being associated with a first category. The series of acts 800 may further include in response to detecting the selection of the first interactive element, providing a second set of interactive elements associated with corresponding topics from a grouping of topics included within the first category, each interactive element from the second set of interactive elements being displayed at a location within the graphical representation based on a corresponding metric of importance and metric of impact for an associated topic.

In one or more embodiments, the series of acts 800 includes detecting a selection of an interactive element from the plurality of interactive elements being associated with a topic from the set of topics. The series of acts 800 may further include, in response to detecting the selection of the interactive element, providing a display of a plurality of snippets from respective documents of the collection of documents referencing the topic.

In one or more embodiments, the series of acts 800 may include receiving additional documents including additional text associated with the one or more entities, modifying the metrics of importance and metrics of impact based on additional instances of topics from the set of topics within the additional documents, and modifying a display of the graphical presentation based on the modified metrics of importance and the modified metrics of impact. In one or more embodiments, the series of acts 800 further includes providing a visualization of one or more changes in the metrics of importance and the metrics of impact for respective topics from the set of topics over time in view of additional documents received over a period of time.

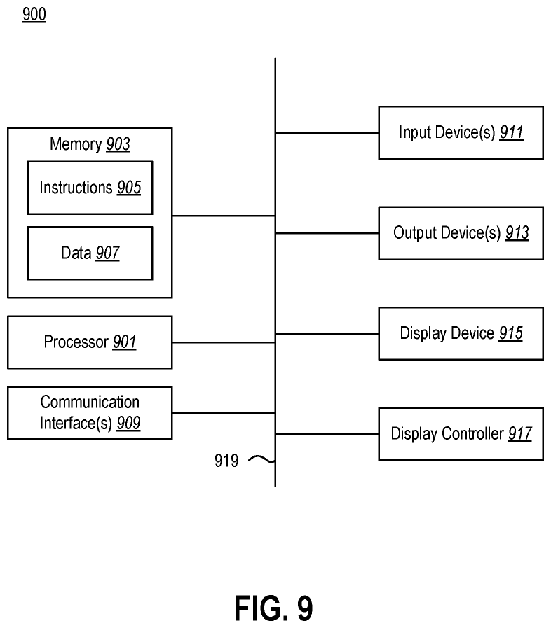

FIG. 9 illustrates certain components that may be included within a computer system 900. One or more computer systems 900 may be used to implement the various devices, components, and systems described herein.

The computer system 900 includes a processor 901. The processor 901 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method being implemented on a computer system having one or more processors, the method comprising:
receiving a collection of documents including text content associated with one or more entities;
tagging each document from the collection of documents with metadata indicating one or more identified categories of the document based on an analysis of the text content included within the document;
determining, for a set of topics, metrics of importance and metrics of impact associated with the one or more entities; and
providing a graphical representation including a plurality of interactive elements to be displayed on a graphical user interface based on a combination of the determined metrics of importance and the metrics of impact associated with respective topics from the set of topics.

2. The method of claim 1, wherein receiving the collection of documents including receiving a first set of documents from a first communication platform and a second set of documents from a second communication platform.

3. The method of claim 1, wherein the text content includes unstructured text, and wherein the method further comprises applying a machine learning model to each document from the collection of documents, the machine learning model being trained to analyze the unstructured data and output at least one identified topic of the document.

4. The method of claim 1, wherein the collection of documents includes one or more of:
a plurality of digital content items shared via a social networking system;
a plurality of user-composed social networking posts shared via the social networking system; or
a plurality of digital content items shared across a plurality of social networking systems.

5. The method of claim 1, wherein receiving the collection of documents associated with the one or more entities includes identifying a set of documents that reference one or more of an organization, a product, or a brand associated with the one or more entities.

6. The method of claim 1, wherein tagging each document includes adding metadata to a document file for each of any number of identified topics referenced by text content included within the document.

7. The method of claim 1, further comprising identifying the set of topics from a plurality of topics associated with one or more documents from the collection of documents, the set of topics including a subset of topics from the plurality of topics.

8. The method of claim 7, wherein the subset of topics are identified based on the subset of topics corresponding to each topic from the subset of topics being associated with a threshold number of tagged documents from the collection of documents.

9. The method of claim 7, wherein the subset of topics are identified based on metrics of importance and metrics of impact for the subset of topics being higher than one or more threshold metrics of importance and impact.

10. The method of claim 1, wherein determining the metrics of importance for the set of topics includes:
identifying the set of topics from a plurality of topics discussed within the collection of documents;
ranking the set of topics based on a frequency with which the respective topics are discussed within the collection of documents; and
calculating a metric for each topic from the set of topics based on a magnitude with which the topic is discussed relative to other topics within the set of topics.

11. The method of claim 10, wherein determining the metrics of impact for the set of topics includes, for each topic from the set of topics:
determining an estimated cost associated with solving a problem associated with the topic;
determining an estimated benefit associated with solving the problem associated with the topic; and
calculating a benefit to cost ratio based on a comparison of the determined estimated benefit and the determined estimated cost.

12. The method of claim 1, further comprising identifying one or more categories including discrete groupings of topics from the set of topics, wherein providing the graphical representation includes displaying an interactive element for each category of the one or more categories based on a combination of metrics of importance and metrics of impact for topics included within the category.

13. The method of claim 12, further comprising:
detecting a selection of a first interactive element from the plurality of interactive elements, the first interactive element being associated with a first category;
in response to detecting the selection of the first interactive element, providing a second set of interactive elements associated with corresponding topics from a grouping of topics included within the first category, each interactive element from the second set of interactive elements being displayed at a location within the graphical representation based on a corresponding metric of importance and metric of impact for an associated topic.

14. The method of claim 13, further comprising:
detecting a selection of an interactive element from the plurality of interactive elements being associated with a topic from the set of topics;
in response to detecting the selection of the interactive element, providing a display of a plurality of snippets from respective documents of the collection of documents referencing the topic.

15. The method of claim 1, further comprising:
receiving additional documents including additional text associated with the one or more entities;
modifying the metrics of importance and metrics of impact based on additional instances of topics from the set of topics within the additional documents; and
modifying a display of the graphical presentation based on the modified metrics of importance and the modified metrics of impact.

16. The method of claim 15, further comprising providing a visualization of one or more changes in the metrics of importance and the metrics of impact for respective topics from the set of topics over time in view of additional documents received over a period of time.

17. A system, comprising:
one or more processors;
memory in electronic communication with the one or more processors; and
instructions stored in the memory, the instructions being executable by the one or more processors to:
receive a collection of documents including text content associated with one or more entities;
tag each document from the collection of documents with metadata indicating one or more identified categories of the document based on an analysis of the text content included within the document;
determine, for a set of topics, metrics of importance and metrics of impact associated with the one or more entities; and
provide a graphical representation including a plurality of interactive elements to be displayed on a graphical user interface based on a combination of the determined metrics of importance and the metrics of impact associated with respective topics from the set of topics.

18. The system of claim 17, wherein the text content includes unstructured data, and wherein the instructions are further executable to apply a machine learning model to each document from the collection of documents, the machine learning model being trained to analyze the unstructured data and output at least one identified topic of the document.

19. The system of claim 17, wherein the instructions that determine the metrics of importance for the set of topics include instructions for:
identifying the set of topics from a plurality of topics discussed within the collection of documents;
ranking the set of topics based on a frequency with which the respective topics are discussed within the collection of documents; and
calculating a metric for each topic from the set of topics based on a magnitude with which the topic is discussed relative to other topics within the set of topics.

20. The system of claim 19, wherein the instructions that determine the metrics of impact for the set of topics includes instructions for:
determining an estimated cost associated with solving a problem associated with a topic;
determining an estimated benefit associated with solving the problem associated with the topic; and
calculating a benefit to cost ratio based on a comparison of the determined estimated benefit and the determined estimated cost.
